(19) United States
(12) Patent Application Publication
(10) Pub. No.: US 2010/0212959 A1
(43) Pub. Date: Aug. 26, 2010

(54) CONTACTING CONFIGURATION AND CONTACTING METHOD FOR CONDUCTOR TRACKS IN MOTOR VEHICLE WINDOW PANES

(76) Inventor: Bernd Flick, Diekholzen (DE)

Correspondence Address: KENYON & KENYON LLP, ONE BROADWAY, NEW YORK, NY, 10004, US

(21) Appl. No.: 12/680,665

(22) PCT Filed: Aug. 27, 2008
(86) PCT No.: PCT/EP08/61172

§ 371 Date: Mar. 29, 2010

(30) Foreign Application Priority Data
Sep. 27, 2007 (DE) 10 2007 046 320.2

(51) Int. Cl. H01R 4/04; H01R 43/00

(52) U.S. Cl. 174/84 R; 29/825

(57) ABSTRACT

A configuration and a method for establishing an electrical connection between a connecting contact of a conductor track in or on a window pane of a motor vehicle and an associated connecting contact of the motor vehicle. It is provided that the two connecting contacts be connected to each other during the mounting of the window pane, by an electrically conductive elastomer material, which may be applied, as a section of an elastic bead of adhesive and/or elastic bead of gasket used for fastening and/or sealing the window pane, onto the window pane or onto a window frame of the motor vehicle.

### RELATED APPLICATION INFORMATION

The present application is a U.S. national phase application of PCT/EP2008/061172, which claims priority to and the benefit of German patent application no. DE 102007046320.2, which was filed in Germany on Sep. 27, 2007, the disclosures of all of which are incorporated herein by reference.

### FIELD OF THE INVENTION

The present invention relates to a configuration and a method for establishing an electrical connection between a connecting contact of a conductor track in or on a motor vehicle window pane and an associated connecting contact of the motor vehicle.

### BACKGROUND INFORMATION

Conductor tracks that are integrated into motor vehicle window panes or are mounted on one of their surfaces are able to be used to heat the window pane and/or as an antenna. For this purpose, the conductor tracks are usually developed in the form of meandering foil strips or in the form of thin heating or antenna wires, which, in the case of window panes having double glazing, as in many front window panes, are usually situated between two laminated glass layers of the pane that are adhered to each other, while in the case of window panes having single glazing, as in the case of many rear window panes, they are situated on the window pane.

While window defrosters are mostly used in rear window panes of passenger vehicles, antennas may also be integrated into front window panes of motor vehicles. In both cases, the conductor tracks usually have two connecting contacts lying in the vicinity of an edge of the window pane which, in the case of heaters, have to be connected to associated connecting contacts of a current supply terminal or a ground terminal of a heater current circuit of the motor vehicle, and in the case of antennas, have to be connected to associated connecting contacts of an antenna cable leading to a radio receiver of the motor vehicle.

The window pane is generally mounted in the window frame of the motor vehicle before the production of the electrical connection between the two connecting contacts of the conductor track in the window pane and the respectively associated connecting contacts of the motor vehicle. Front or back window panes of motor vehicles, equipped with conductor tracks, are therefore provided with an encircling elastic bead of adhesive, of silicone rubber, along their edges or another pasty adhesive or sealing material which, when the window pane is installed in the window frame, is pressed against the latter, in order to fasten the window pane to the frame and to seal it all the way around. After the mounting of the window pane, the electrical connections are produced, in that, for example, two complementary connecting contacts of a connecting cable are directly soldered on to the connecting contacts of the window pane developed as soldering terminal.

Alternatively one could first solder a plug pin of a female connector to each soldering terminal and then produce a detachable plug connection between the female connector and a plug connector of the connecting cable, as is discussed, for instance, in EP 0 776 066 B1. Furthermore, two flat metallic conductors adhered to a polyimide foil could be soldered onto the soldering terminals, and the foil including the conductors could be passed through between the window pane and an adhesive and/or elastic bead of gasket used to fasten the pane, as is discussed in DE 100 30 066 B4. A terminal using spring contacts is also known which, however, the same as the other methods for contacting the conductor tracks, is very time consuming and laborious.

Starting from this, the exemplary embodiments and/or exemplary methods of the present invention is based on the object of improving a configuration and a method of the type named at the outset, with the purpose that the expenditure of time and work for establishing the electrical connection between the connecting contacts of the conductor tracks integrated into the window pane, or situated on the window pane, and the associated connecting contacts of the motor vehicle is able to be reduced.

### SUMMARY OF THE INVENTION

This object may be attained, according to the exemplary embodiments and/or exemplary methods of the present invention, by connecting the two connecting contacts to each other by an electrically conductive elastomer material.

The combination of features according to the exemplary embodiments and/or exemplary methods of the present invention permits undertaking the fastening of the window pane and the electrical contacting of the conductor track in a single work step, by making an elastic bead of adhesive or elastic bead of gasket, used for fastening the window pane to a window frame of the motor vehicle and/or for sealing the window opening around the window pane between associated connecting contacts of the window pane and of the motor vehicle, of an electrically conductive elastomer material, while it is made of an electrically insulating elastomer material between pairs of associated connecting contacts, so as to make contacting possible at different potentials.

Normally, two pairs of connecting contacts are required at the window pane and at the window frame, both for window defrosters and for disk-type antennas. In order to assure a problem-free double change of the elastomer material used between these two pairs of associated connecting contacts, so that the two pairs of connecting contacts are separated by an electrically insulating section of the adhesive and/or elastic bead of gasket, the two pairs of connecting contacts are expediently situated at a distance from each other of more than 50 mm. By contrast to the connecting contacts of known contacting systems, in this context, they may also be situated at different side edges, such as at opposite side edges of the window pane.

In order to take care that there is a good electrical contact between two associated connecting contacts and the electrically conductive elastomer material situated between the connecting contacts, the two connecting contacts expediently have a large bare contact surface, which is in contact with the electrically conductive elastomer material and may be able to be embedded in it.

In order to hold the resistance of the electrically conductive elastomer material to as low as possible, the associated connecting contacts are expediently situated on opposite edge sections of the window pane and the window frame of the motor vehicle, in order to keep the distance between the associated connecting contacts low.

The electrically conductive elastomer material and the electrically insulating elastomer material are expediently made of the same base material, which may include a silicone rubber, the base material of the first-named elastomer material having suitable additives or fillers added to it, so that the elastomer material becomes electrically conductive.

The exemplary embodiments and/or exemplary methods of the present invention will now be explained in detail, in light of exemplary embodiments shown in the drawings.

### BRIEF DESCRIPTION OF THE DRAWINGS

FIG. 1 shows a top view onto a rear window of a motor vehicle that is provided with an antenna.

FIG. 2 shows a top view onto a rear window after the application of an elastic bead of adhesive and elastic bead of gasket used for fastening and sealing the rear window, that has electrically conductive and electrically insulating sections.

FIG. 3 shows a sectional view along the line of FIG. 2.

FIG. 4 shows a top view onto a rear window furnished with a heating field and an antenna, corresponding to FIG. 2, after the application of an elastic bead of adhesive and elastic bead of gasket.

### DETAILED DESCRIPTION

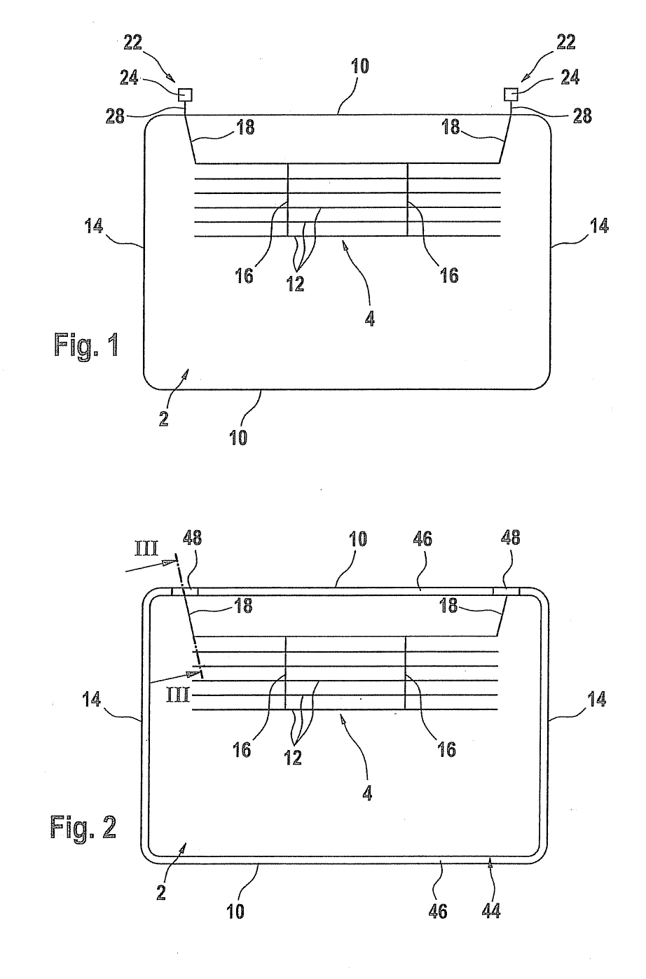

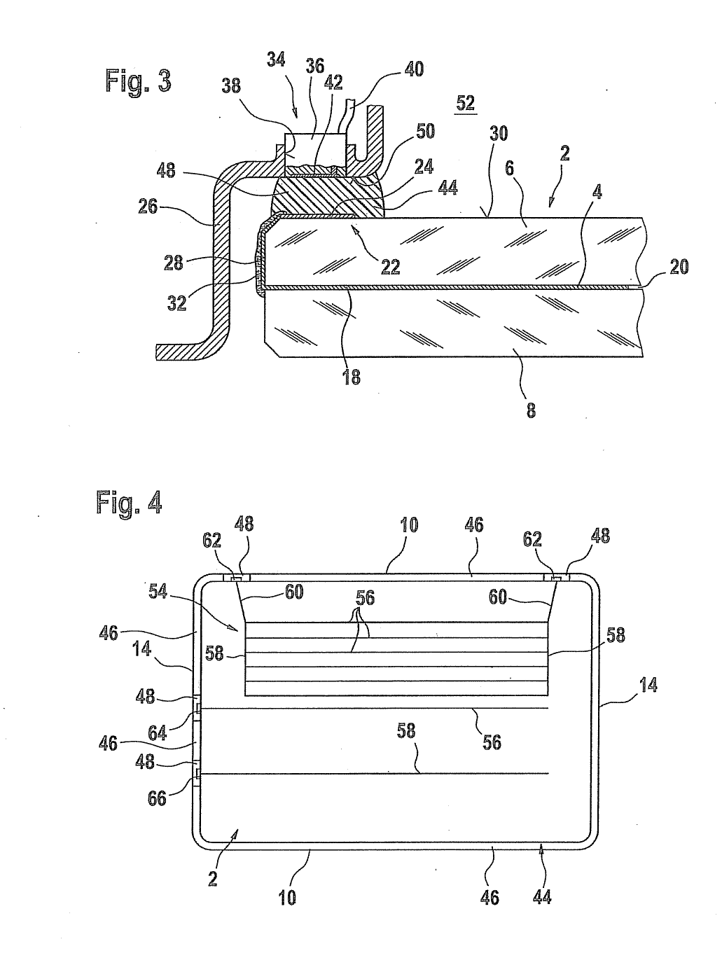

Double-glazed-rectangular rear window 2, of a passenger car, shown in FIGS. 1 through 3 is equipped with an antenna 4 for a radio receiver of the passenger car. Antenna 4 is situated between two laminated glass layers 6, 8, that are adhered to each other (FIG. 3), of rear window 2. It is made essentially of a plurality of thin antenna wires 12 that are parallel to the longitudinal side edges 10 of rear window 2, which are connected by two connecting wires 16 that are parallel to narrow side edges 14 of rear window 2. Antenna wire 12 nearest to upper longitudinal side edge 10 of rear window 2 is connected to two connecting wires 18 at its opposite end faces, which proceed from space 20 between the two laminated glass layers 6, 8 at a greater lateral distance. Connecting wires 18 are provided at their ends 28 with connecting contacts 22, that are soldered on, in the form of thin metallic contact plates 24, as shown in FIG. 1.

As is shown best in FIG. 3, in the example of one of the two connecting wires 18, before the mounting of rear window 2, end 28 that extends beyond side edge 10 of rear window 2 is guided by each of connecting wires 18, in an associated window frame 26 of the passenger car, against the longitudinal side edge of inner laminated glass pane 6, lying against it up to inner side 30 of rear window 2, where contact plate 24 that is soldered to end 28 of connecting wire 18 becomes adhered to inner side 30 of rear window 2 in the immediate vicinity of longitudinal side edge 10 of rear window 2. In order to avoid damage to ends 28 of connecting wires 18, these may be coated using an insulating protective lacquer 32 or the like, the bare faces of metallic contact plates 24 facing away from the inner side of rear window 2 remaining free, however.

Two connecting contacts 34 on the motor vehicle side are mounted in window frame 26 used to accommodate rear window 2, before mounting rear window 2. However, in the specific embodiment shown in FIG. 3, each of the two connecting contacts 34 includes a molded article 36, made of plastic, which may be latched into a corresponding recess 38 of window frame 26. Molded article 36 is also equipped with a contact plate 42 at its outer side pointing in the direction of rear window 2, which is connected on the inside of molded article 36 to one of two antenna connecting wires 40 of the motor vehicle. The mounting place of connecting contacts 34 is selected in such a way that, after the insertion of rear window 2 into window frame 26, contact plate 42 of each connecting contact 34 lies exactly opposite associated contact plate 24 of connecting contact 22 of rear window 2, as shown in FIG. 3.

Immediately before the mounting of rear window 2 in window frame 26, an elastic bead of adhesive 44 made of a pasty adhesive and sealing material is applied along side edges 10, 14 of rear window 2 on inner side 30 of the latter.

The adhesive and sealing material of elastic bead of adhesive 44 may be made of a silicone rubber, which sticks to the surfaces of rear window 2 and of window frame 26, and has elastic properties after setting. Whereas along the major part of side edges 10, 14 a usual silicone rubber 46 is used that has electrically insulating properties for developing elastic bead of adhesive 44, however, in the regions of the two pairs of connecting contacts 22, 34 as well as on both sides of these, elastic bead of adhesive 44 is made of a modified silicone rubber 48, which has been given electrically conductive properties by the addition of suitable additives and/or fillers.

The application of the two different adhesive and sealing materials, i.e. electrically insulating silicone rubber 46 and electrically conductive silicone rubber 48, may be made, for example, with the aid of an application nozzle which is able to be connected, by switchable valves, both to a supply of the electrically insulating and the electrically conductive adhesive and sealing material, so that alternatingly one or the other material may be applied, so as to apply the uninterrupted elastic bead of adhesive 44 in such a way as to have electrically insulating sections 48 about the edges 10, 14 of rear window 2, as shown in FIG. 2.

When rear window 2, that is provided with the encircling elastic bead of adhesive 44, is then inserted into window frame 26, elastic bead of adhesive 46 is pressed together a little between inner side 30 of rear window 2 and an opposite surface 50 of window frame 26, so that rear window 2 is fixed in window frame 26 after setting, and is sealed off around window opening 52 from window frame 26. The two electrically conductive sections 48 of elastic bead of adhesive 46 between the two pairs of opposite contact plates 24 and 42 on rear window 2 and at window frame 26, form through-contactings, in this context, which, after the setting of elastic bead of adhesive 44, ensure an electrical connection between associated connecting contacts 22 and 34 of rear window 2 and the passenger car.

In contrast to rear window 2 in FIGS. 1 to 3, rear window 2 shown in FIG. 4 is provided with an heating field 54 used as a rear window defroster, an antenna 56 that is capacitively coupled to the conductor tracks of heating field 54, as well as an additional radiating element 58 for receiving medium wave.

Heating field 54 includes a plurality of heating wires 56 parallel to longitudinal side edge 10 of rear window 2, which are situated in parallel connection between two base wires 58 that are parallel to narrow side edges 14 of rear window 2. The two base wires 58 are each connected by a connecting wire 60 to a connecting contact 62 on inner side 30 of rear window 2, which in turn is connected, by a section 48, made of electrically conductive silicone rubber, of adhesive and elastic bead of gasket 44 used for fastening and sealing rear window 2, to an associated connecting contact situated at window frame 26 of a heating current circuit, as was described above for the pairs of opposite connecting contacts 22 and 34 of antenna 4 in FIGS. 1 to 3.

Antenna 56, which is capacitively coupled to the conductor tracks of heating field 54, and runs at a short distance from the lowest heating wire 56 of heating field 54, and antenna element 58, that runs at a greater distance from antenna 56 and parallel to it, each have only one single connecting contact 64 and 66 for connecting to an opposite connecting contact on the window frame. The two connecting contacts 64, 66 are each connected, in the same manner as connecting contacts 62 of heating field 54 and connecting contacts 32 of antenna 4, of FIGS. 1 through 3, by a section 48, of adhesive and elastic bead of gasket 44, made of electrically conductive silicone rubber, to an associated connecting contact on window frame 26, the positioning being the same as shown in cross section for connecting contacts 22 and 34 in FIG. 3.

The two sections 48 of adhesive and elastic bead of gasket 44, situated in the region of connecting contacts 64, 66, are separated on both sides and between each other by sections 46 made of electrically insulating silicone rubber, so that they are able to have different potentials.

1-11. (canceled)

12. A configuration for establishing an electrical connection, comprising:
an electrically conductive elastomer material; and
a connecting contact of a conductor track in or on a window pane of the motor vehicle electrically connected to an associated connecting contact of the motor vehicle, wherein the connecting contact and the associated connecting contact are connected by the electrically conductive elastomer material.

13. The configuration of claim 12, wherein the connecting contact and the associated connecting contact have contact surfaces which are in contact with or embedded in the electrically conductive elastomer material.

14. The configuration of claim 12, wherein the connecting contact and the associated connecting contact are situated at opposite edge sections of the window pane or of a window frame of the motor vehicle.

15. The configuration of claim 12, wherein the electrically conductive elastomer material forms a section of at least one of an elastic bead of adhesive or an elastic bead of gasket used for at least one of fastening or sealing the window pane.

16. The configuration of claim 15, wherein sections made of the electrically conductive elastomer material and sections made of an electrically insulating elastomer material alternate along at least one of the elastic bead of adhesive or the elastic bead of gasket.

17. The configuration of claim 12, wherein the conductor track has two separate connecting contacts, which are situated at a distance of more than 50 mm from each other.

18. The configuration of claim 12, wherein the electrically conductive elastomer material includes a silicone rubber.

19. A method for establishing an electrically conductive connection between a connecting contact of a conductor track in or on a window pane of a motor vehicle and an associated connecting contact of the motor vehicle, the method comprising:
connecting the connecting contact and the associated connecting contact to each other by an electrically conductive elastomer material during an assembly of the window pane in the motor vehicle.

20. The method of claim 19, wherein the electrically conductive elastomer material is applied in a pasty form to a contact surface of one of the connecting contacts of the window pane or the motor vehicle and is brought into contact with a contact surface of the other of the two connecting contacts during an insertion of the window pane.

21. The method of claim 19, wherein the electrically conductive elastomer material is applied onto the window pane or the window frame of the motor vehicle as a section of at least one of an elastic bead of adhesive or an elastic bead of gasket, for at least one of fastening or sealing the window pane.

22. The method of claim 21, wherein the electrically conductive elastomer material and an electrically insulating elastomer material are applied alternately as adjacent sections of at least one of the elastic bead of adhesive and the elastic bead of gasket.
